(19) United States
(12) Patent Application Publication
(10) Pub. No.: US 2005/0198639 A1
(43) Pub. Date: Sep. 8, 2005

(54) Process management apparatus, user terminal apparatus, process management method, and process execution method

(76) Inventor: Yoshiro Matsui, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/061,636

(22) Filed: Feb. 22, 2005

(30) Foreign Application Priority Data
Feb. 23, 2004 (JP) 2004-046861
Jan. 28, 2005 (JP) 2005-021498

(51) Int. Cl. G06F 17/60

(52) U.S. Cl. 718/100

(57) ABSTRACT

A process management apparatus is disclosed that includes a process execution control part configured to control execution of a process. The process execution control part retrieves multiple process definitions that are process templates based on context information relating to the execution of the process, and merges the retrieved process definitions into a process definition or reconfigures a process definition based on the retrieved process definitions, so as to allow a user to proceed with the process without selecting the process definition.

### BACKGROUND OF THE INVENTION

1. Field of the Invention

The present invention relates to a process management apparatus, a user terminal apparatus, a process management method, a process execution method, and recording media on which programs for causing a computer to execute such methods are recorded.

2. Description of the Related Art

In these years, a workflow system has become well known that manages and automates a flow of documents or information from one person to another, when multiple persons work via a network, so as to facilitate their work. Such a workflow system is disclosed, for instance, in Haruo Hayami; “Expanding Workflow Management System: 1,” IPSJ (Information Processing Society of Japan) Magazine, Vol. 39, No. 11, pp. 1160-1165 (1998); Haruo Hayami, Toshiaki Sakaguchi, and Ryoichi Shibuya; “Expanding Workflow Management System: 2,” IPSJ Magazine, Vol. 39, No. 12, pp. 1258-1263 (1998); and Haruo Hayami, Ryoichi Shibuya, Takao Suzuki, Junichi Ikoma, Yosuke Terashita, Naoki Ueno, Satoshi Kaneko, and Kiyoshi Hayashi; “Expanding Workflow Management System: 3,” IPSJ Magazine, Vol. 40, No. 5, pp. 507-513 (1999).

A workflow system in which a workflow participant can change a process in execution while executing the process is also possible. In such a workflow system, the result of actual execution can be reflected in a process definition by reusing the process changed by the workflow participant during its execution as a process definition.

However, in such a workflow system, workflow participants reenter different processes that the workflow participants have changed respectively during their execution in, for instance, the workflow system as process definitions. Therefore, there exist many process definitions that perform tasks of the same kind. This causes a problem in that it is difficult for a user to determine which process definition to select in starting workflow-related processing.

### SUMMARY OF THE INVENTION

Accordingly, it is a general object of the present invention to provide a process management apparatus, a user terminal apparatus, a process management method, and a process execution method in which the above-described disadvantage is eliminated.

A more specific object of the present invention is to provide a process management apparatus, a user terminal apparatus, a process management method, and a process execution method that enable a user to proceed with a workflow without selecting a process definition at the beginning.

Another more specific object of the present invention is to provide recording media on which programs for causing a computer to execute such methods are recorded.

One or more of the above objects of the present invention are achieved by a process management apparatus including a process execution control part configured to control execution of a process, the process execution control part being configured to retrieve multiple process definitions that are process templates based on context information relating to the execution of the process, and to perform one of merging of the retrieved process definitions into a process definition and reconfiguration of a process definition based on the retrieved process definitions, so as to allow a user to proceed with the process without selecting the process definition.

One or more of the above objects of the present invention are also achieved by a user terminal apparatus including a process editing part configured to perform process editing, the process editing part being configured to display on a screen one of a first process into which multiple processes are merged and a second process reconfigured based on the multiple processes, and to display context information relating to execution of the one of the first and second processes in response to a request.

One or more of the above objects of the present invention are also achieved by a computer-readable recording medium on which a program for causing a computer to execute a method of managing a process is recorded, the method including the step of controlling execution of the process, wherein the step retrieves multiple process definitions that are process templates based on context information relating to the execution of the process, and performs one of merging of the retrieved process definitions into a process definition and reconfiguration of a process definition based on the retrieved process definitions, so as to allow a user to proceed with the process without selecting the process definition.

One or more of the above objects of the present invention are also achieved by a computer-readable recording medium on which a program for causing a computer to execute a method of process execution is recorded, the method including the step of performing process editing, wherein the step displays on a screen one of a first process into which multiple processes are merged and a second process reconfigured based on the multiple processes, and displays context information relating to execution of the one of the first and second processes in response to a request.

One or more of the above objects of the present invention are also achieved by a method of managing a process in a process management apparatus, the method including the step of controlling execution of the process, wherein the step retrieves multiple process definitions that are process templates based on context information relating to the execution of the process, and performs one of merging of the retrieved process definitions into a process definition and reconfiguration of a process definition based on the retrieved process definitions, so as to allow a user to proceed with the process without selecting the process definition.

One or more of the above objects of the present invention are also achieved by a method of process execution in a user terminal apparatus, the method including the step of performing process editing, wherein the step displays on a screen one of a first process into which multiple processes are merged and a second process reconfigured based on the multiple processes, and displays context information relating to execution of the one of the first and second processes in response to a request.

According to the present invention, a user can proceed with a workflow without selecting a process definition at the beginning.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a hardware configuration of a server according to a first embodiment of the present invention;

FIG. 2 is a block diagram illustrating a hardware configuration of a client according to the first embodiment of the present invention;

FIG. 3 is a schematic diagram for illustrating the terms employed in this specification;

FIG. 4 is a schematic diagram illustrating a software configuration according to the first embodiment of the present invention;

FIG. 5 is a diagram for illustrating a method of merging process definitions according to the first embodiment of the present invention;

FIG. 6 is a diagram for illustrating the method of merging process definitions according to the first embodiment of the present invention;

FIG. 7 is a diagram for illustrating the method of merging process definitions according to the first embodiment of the present invention;

FIG. 8 is a diagram for illustrating reconfiguration of a process definition according to the first embodiment of the present invention;

FIG. 9 is a sequence diagram illustrating a process starting operation according to the first embodiment of the present invention;

FIG. 10 is a sequence diagram illustrating a process advancing operation according to the first embodiment of the present invention;

FIG. 11 is a diagram illustrating a standard flow relating to application for an overseas business trip according to the first embodiment of the present invention;

FIG. 12 is a diagram illustrating Flow A relating to application for an overseas business trip according to the first embodiment of the present invention;

FIG. 13 is a diagram illustrating Flow B relating to application for an overseas business trip according to the first embodiment of the present invention;

FIG. 14 is a diagram illustrating Flow C relating to application for an overseas business trip according to the first embodiment of the present invention;

FIG. 15 is a diagram illustrating Flow D relating to application for an overseas business trip according to the first embodiment of the present invention;

FIG. 16 is a diagram illustrating Flow E relating to application for an overseas business trip according to the first embodiment of the present invention;

FIG. 17 is a diagram illustrating a flow relating to application for an overseas business trip according to the first embodiment of the present invention;

FIG. 18 is a diagram illustrating a case of displaying a process context according to the first embodiment of the present invention;

FIG. 19 is a diagram illustrating a case of adding an activity according to the first embodiment of the present invention;

FIG. 20 illustrates tables included in a process instance database according to the first embodiment of the present invention;

FIG. 21 illustrates tables included in a process context database according to the first embodiment of the present invention; and

FIG. 22 is a diagram illustrating another configuration of the process context database according to the first embodiment of the present invention.

### DETAILED DESCRIPTION OF THE PREFERRED EMBODIMENTS

A description is given below, with reference to the accompanying drawings, of embodiments of the present invention.

### First Embodiment

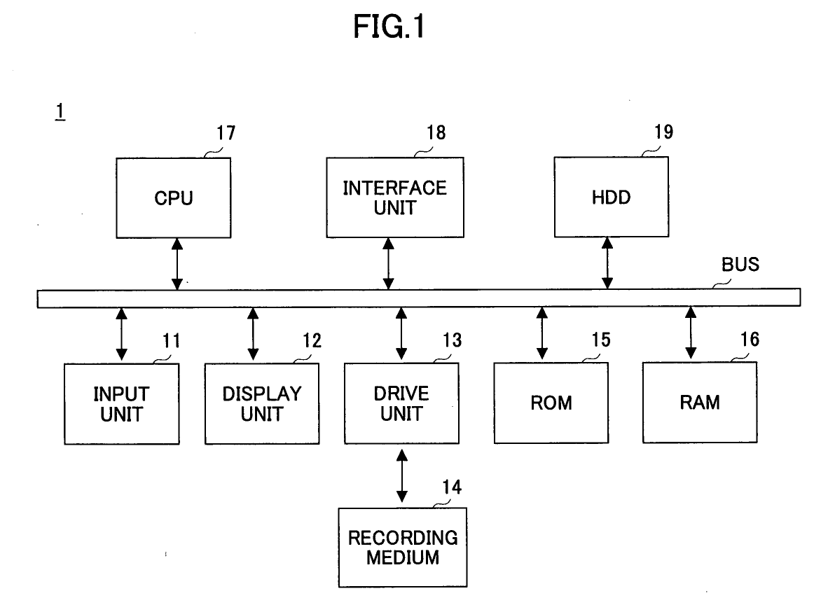

First, a description is given, with reference to FIG. 1, of a hardware configuration of a server 1 (a process management apparatus) according to a first embodiment of the present invention. FIG. 1 is a block diagram illustrating a hardware configuration of the server 1.

The hardware configuration of the server 1 illustrated in FIG. 1 includes an input unit 11, a display unit 12, a drive unit 13, a ROM (Read-Only Memory) 15, a RAM (Random Access Memory) 16, a CPU (Central Processing Unit) 17, an interface unit 18, and an HDD (Hard Disk Drive) 19, which are interconnected through a bus.

The input unit 11 includes a keyboard and a mouse operated by a user of the server 1. The input unit 11 is used to input various operational signals to the server 1. The display unit 12 includes a display used by the user of the server 1, and displays a variety of information items. The interface unit 18 connects the server 1 to a network or the like.

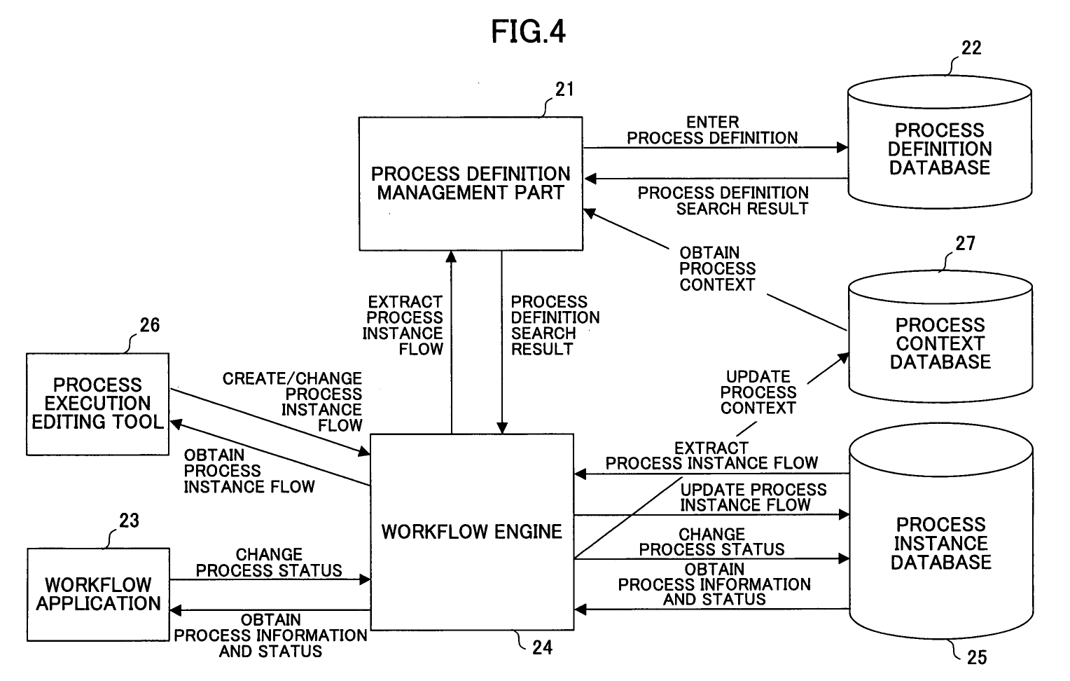

A below-described process definition management part 21, process definition database 22 (a process definition storage part), workflow engine 24 (a process execution control part), process context database 27 (a context information storage part), and process instance database 25 (FIG. 4), which are programs corresponding to software, are provided to the server 1 by a recording medium 14 such as a CD-ROM, or are downloaded to the server 1 through the network, for instance. The recording medium 14 is set in the drive unit 13, so that the programs are installed in the HDD 19 through the drive unit 13 from the recording medium 14.

The ROM 15 stores data. The RAM 16 stores the program read out from the HDD 19 when the server 1 is started. The CPU 17 performs processing in accordance with the program stored in the RAM 16.

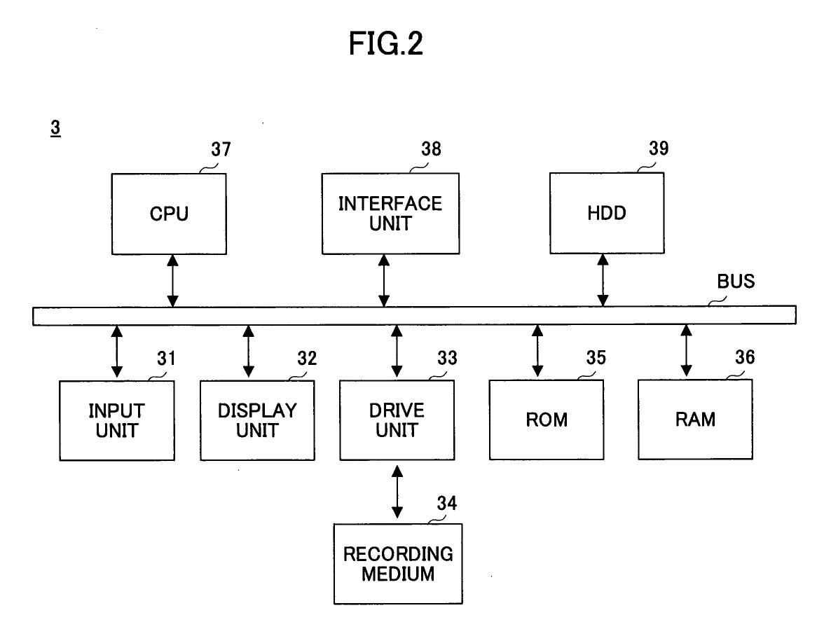

Next, a description is given, with reference to FIG. 2, of a hardware configuration of a client 3 (a user terminal apparatus) according to the first embodiment of the present invention. FIG. 2 is a block diagram illustrating a hardware configuration of the client 3.

The hardware configuration of the client 3 illustrated in FIG. 2 includes an input unit 31, a display unit 32, a drive unit 33, a ROM 35, a RAM 36, a CPU 37, an interface unit 38, and an HDD 39, which are interconnected through a bus.

The input unit 31 includes a keyboard and a mouse operated by a user of the client 3. The input unit 31 is used to input various operational signals to the client 3. The display unit 32 includes a display used by the user of the client 3, and displays a variety of information items. The interface unit 38 connects the client 3 to the network.

A below-described process execution editing tool 26 (a process editing part) and workflow application 23 (FIG. 4), which are programs corresponding to software, are provided to the client 3 by a recording medium 34 such as a CD-ROM, or are downloaded to the client 3 through the network, for instance. The recording medium 34 is set in the drive unit 33, so that the programs are installed in the HDD 39 through the drive unit 33 from the recording medium 34.

The ROM 35 stores data. The RAM 36 stores the program read out from the HDD 39 when the client 3 is started. The CPU 37 performs processing in accordance with the program stored in the RAM 36.

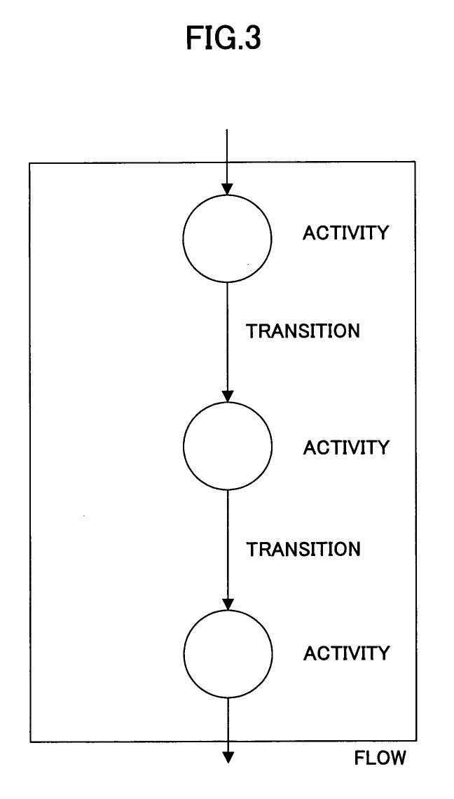

Next, a description is given, with reference to FIG. 3, of terms employed in this specification. FIG. 3 is a schematic diagram for illustrating the terms employed in this specification.

In this specification, a process refers to a processing flow for carrying out a task. An activity refers to each of the jobs forming the process. The activity has states such as ACTIVATED, COMPLETED, and WAITING. For instance, a below-described workflow system composed of software (hereinafter, also simply referred to as “workflow system”) expresses the progress of the process by the transition of these states. A transition defines the order of execution of activities. The transition also has a condition (state), and the workflow system determines the state transition condition of an activity to connect based on the condition.

A flow is a flowchart of processing expressed by activities and transitions. A process definition is a process template, and defines the flow of a process before execution. A process instance flow is the flow of a process in execution (that is being executed).

A process instance is a substantiated process definition, and includes the actual contents of a task. The above-described process instance flow is the flow definition of a process instance. Normally, the process instance flow is equal to its base process definition.

However, as described below, the process instance flow and the process definition are treated as different entities and are separately operable in this workflow system. Accordingly, in this workflow system, a change in the process instance flow is prevented from being reflected in its base process definition, and a change in the process definition is also prevented from being reflected in a process that has already been converted into an instance.

Next, a description is given, with reference to FIG. 4, of a configuration of software installed in the server 1 and the client 3 according to the first embodiment of the present invention. FIG. 4 is a schematic diagram illustrating a software configuration according to the first embodiment of the present invention.

The software configuration illustrated in FIG. 4 includes the process definition management part 21, the process definition database 22, the workflow application 23, the workflow engine 24, the process instance database 25, the process execution editing tool 26, and the process context database 27.

The process definition management part 21 manages process definitions stored in the process definition database 22. In response to a request, the process definition management part 21 retrieves a process definition from the process definition database 22 based on a process context (context information), and provides the process definition to the workflow engine 24. The process definition management part 21 also extracts a process instance flow from the process instance database 25 through the workflow engine 24. The process definition management part 21 also obtains a process context from the process context database 27, and enters the extracted process instance flow or the process definition thereof in the process definition database 22 as a process definition, correlating the extracted process instance flow or the process definition thereof with the obtained process context.

Here, the term “process context.” refers to information that forms the context and/or background of process execution. Examples of the process context may be a section to which an executor of a process or activity belongs, the title and the echelon of the executor, the type and the attribute of a task or job that is the purpose of a process or activity, the start time, the end time, and the elapsed time of a process or activity, and the execution cost of a process or activity. The process context may also be defined as all information (information items) relating to process execution. Depending on business applications realized by workflow systems, the following may also be considered as process contexts in addition to those described above: customer information such as the age, the gender, the annual income, the number of complaints made, and the purchase history of a customer in the case of CRM (Customer Relationship Management); customer information such as the scale and the management indexes of an industrial customer and trading information such as the type, the commodity, and the period before a delivery date of a customer's business item in the case of SFA (Sales Force Automation); and merchandise information and business partner (customer) information in the case of SCM (Supply Chain Management).

A change in the process context is caused by entry of an attribute such as the result of a process or activity, selection at an XOR-Split (XOR branching point) by a user, or a change in a process in execution.

The process definition database 22 stores process definitions. For instance, the process definition database 22 stores numerous process definitions of the same kind. The process definitions of the same kind refer to process definitions that define processes performing the tasks of the same kind or achieving the purposes of the same kind.

The workflow application 23 executes activities. Through the workflow engine 24, the workflow application 23 obtains the process information and the process status of a corresponding process instance stored in the process instance database 25, and changes the process status.

Based on a request from the workflow application 23, the workflow engine 24 obtains the process information and the process status of a corresponding process instance from the process instance database 25, and changes the process status of the corresponding process instance stored in the process instance database 25.

Further, the workflow engine 24 extracts a process instance flow from the process instance database 25 in response to a request from the process execution editing tool 26. The workflow engine 25 also updates a process instance flow stored in the process instance database 25 in response to a request from the process execution editing tool 26. The updating of the process instance flow includes suspension of an activity, advance execution of an activity, and addition of an activity.

Further, as described below, the workflow engine 24 merges process definitions obtained from the process definition database 22, and reconfigures a process definition when the process context is changed during execution of a process. The merging of process definitions and the reconfiguration of a process definition may be performed by the process definition management part 21 in response to a request from the workflow engine 24. Further, based on an instruction from a user, the merging of process definitions and the reconfiguration of a process definition may also be performed in the process execution editing tool 26 that has obtained the process definitions through the workflow engine 24. The same holds true for the following.

Further, the workflow engine 24 stores a process context in the process context database 27 at the time of execution of a process.

The process instance database 25 stores process instances.

The process execution editing tool 26 edits a process instance flow. The process execution editing tool 26 obtains a process instance flow from the process instance database 25 through the workflow engine 24, and edits the obtained process instance flow. The process execution editing tool 26 stores the edited process instance flow in the process instance database 25 through the workflow engine 24, thereby updating the process instance flow.

The process context database 27 stores process contexts.

As described above, for instance, the process execution editing tool 26 and the workflow application 23 are installed in the client 3, and the process definition management part 21, the process definition database 22, the workflow engine 24, the process instance database 25, and the process context database 27 are installed in the server 1. Further, the process execution editing tool 26, the workflow application 23, the process definition management part 21, the process definition database 22, the workflow engine 24, the process instance database 25, and the process context database 27 may be installed as Web services. In this configuration, communications are performed between the client 3 and the server 1 in accordance with SOAP (Simple Object Access Protocol) based on XML (extensible Markup Language) or HTTP (HyperText Transfer Protocol).

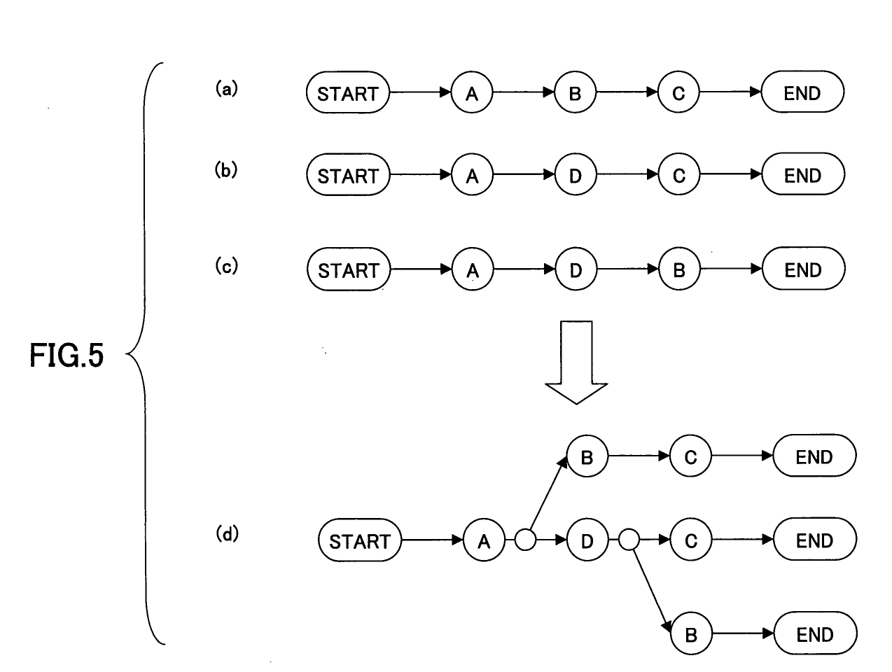

A description is given below, with reference to FIG. 5, of a method of merging process definitions. FIG. 5 is a diagram for illustrating a method of merging process definitions.

Referring to FIG. 5, (a), (b), and (c) indicate the flows of processes defined in respective predetermined process definitions.

First, for instance, the workflow engine 24 compares the flows of the processes defined in their respective process definitions from their beginnings. If the same activity (Activity A in the case of FIG. 5) exists, the workflow engine 24 merges (unifies) the corresponding activities (Activities A of (a), (b), and (c)) into one activity.

Next, if different activities exist, the workflow engine 24 divides the flow using an XOR-Split (XOR branching point). The workflow engine 24 derives a branching condition from the process contexts of the respective process definitions. If it is not possible to determine a branching condition from the process contexts, a workflow participant may determine the branching condition at the time of execution. Hereinafter, the workflow participant is referred to simply as “user.”

The workflow engine 24 performs the above-described processing with respect to each branch of the flow, thereby creating a process definition into which the process definitions are merged (a merged process definition) as indicated in (d) of FIG. 5, for instance.

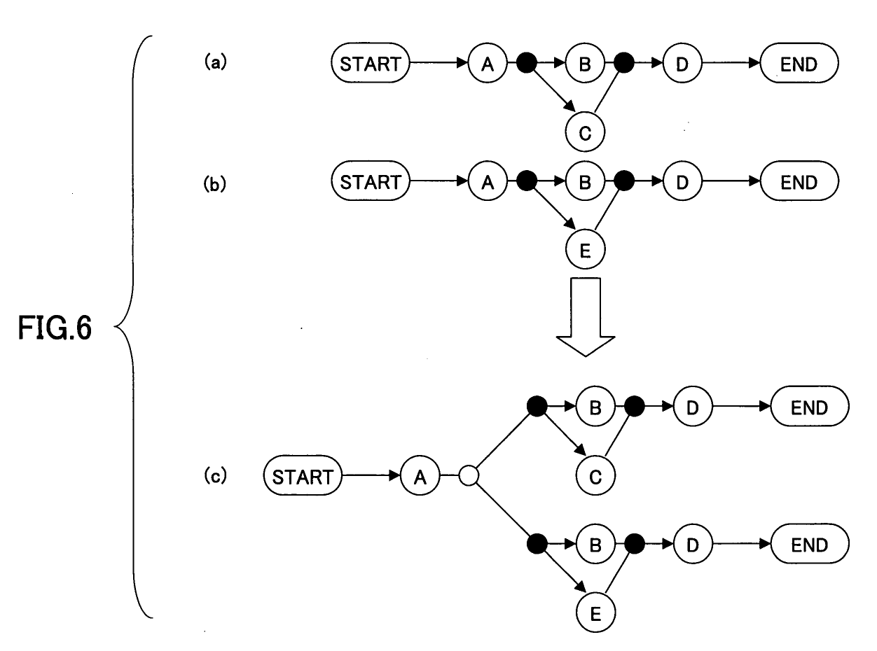

A description is given below, with reference to FIG. 6, of a method of merging process definitions including an AND-Split (AND branching point). FIG. 6 is a diagram for illustrating a method of merging process definitions including AND branching.

Referring to FIG. 6, (a) and (b) indicate the flows of processes defined in respective predetermined process definitions.

For instance, the workflow engine 24 compares the activities of the flows of the processes defined in their respective process definitions. If an AND-Split exists, the workflow engine 24 has the AND-Split preceded by an XOR-Split, considering the AND-Split itself as a single activity.

After the AND-Split, the workflow engine 24 merges the flows as originally defined as illustrated in (c) of FIG. 6.

If AND-Splits match each other while the subsequent activities are different in flows before a merger, the workflow engine 24 merges the flows in such a manner as if the AND-Splits were also different.

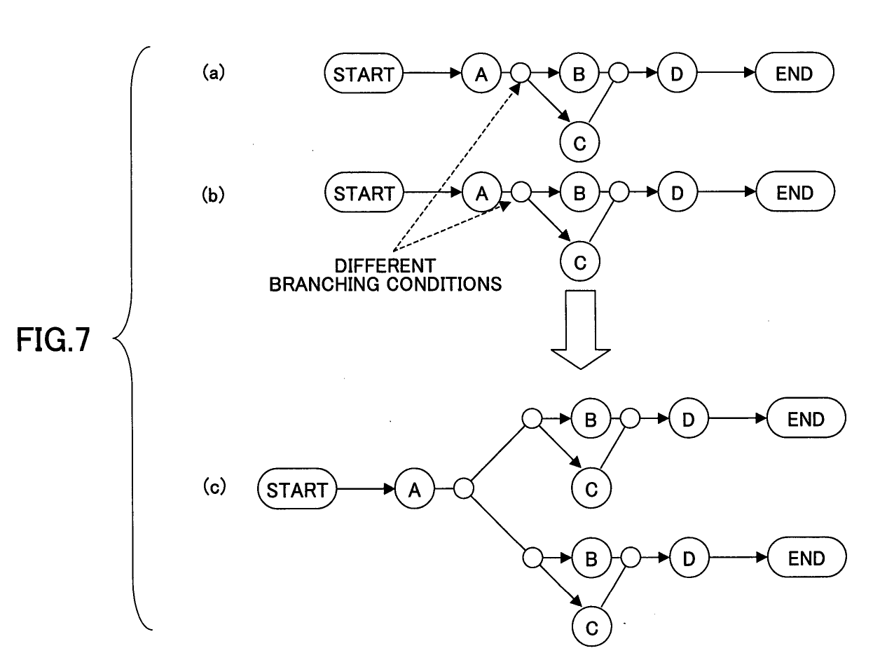

A description is given below, with reference to FIG. 7, of a method of merging process definitions including an XOR-Split. FIG. 7 is a diagram for illustrating a method of merging process definitions including an XOR-Split.

Referring to FIG. 7, (a) and (b) indicate the flows of processes defined in respective predetermined process definitions.

For instance, the workflow engine 24 compares the activities of the flows of the processes defined in their respective process definitions. If an XOR-Split exists in each flow, the workflow engine 24 compares the branching conditions of the XOR-Splits, considering each XOR-Split itself as a single activity.

If the branching conditions as well as the activities subsequent to the XOR-Splits are the same, the workflow engine 24 merges the flows based on the determination that the XOR-Splits are identical. If the branching conditions or the activities subsequent to the XOR-Splits are not the same, the workflow engine 24 merges the flows, having the XOR-Splits preceded by an XOR-Split as illustrated in (c) of FIG. 7.

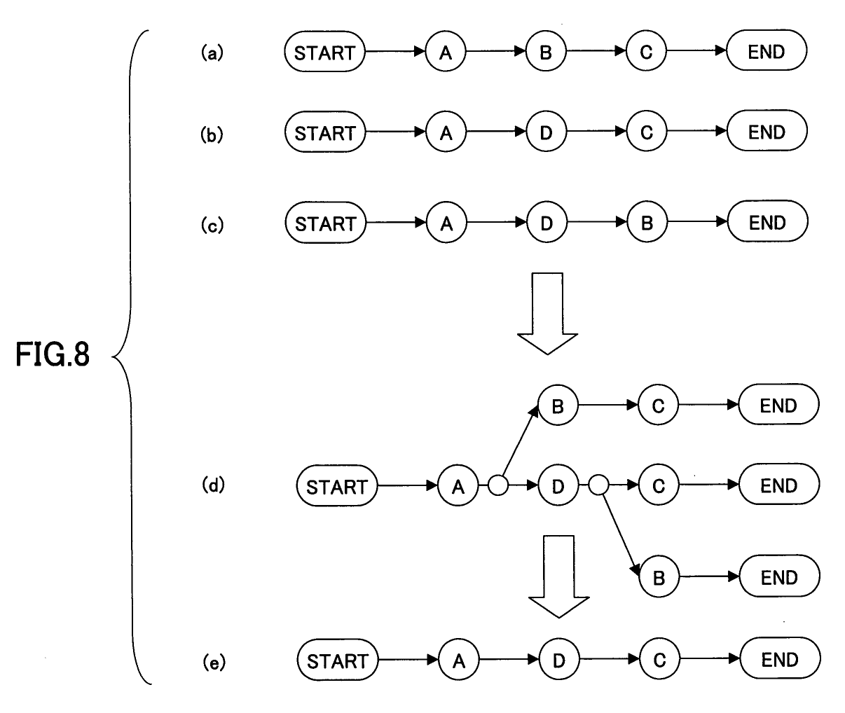

A description is given below, with reference to FIG. 8, of reconfiguration of a process definition. FIG. 8 is a diagram for illustrating reconfiguration of a process definition.

Referring to FIG. 8, (a), (b), and (c) indicate the flows of processes defined in respective predetermined process definitions. Further, (d) indicates the flow of a process showing the result of the merger of the flows of (a), (b), and (c) of FIG. 8.

Here, it is assumed that the process illustrated in (d) of FIG. 8 is executed and the state of Activity D is active (ACTIVATED) and that it has been determined that the process illustrated in (a) of FIG. 8 is not to be executed.

Then, for instance, if it is determined from user settings or the like that the process contexts of the processes illustrated in (a) and (b) match each other, the workflow engine 24 decomposes the process illustrated in (d) into the processes illustrated in (a), (b), and (c).

Next, the workflow engine 24 omits a process that, it is determined, is not to be executed (the process illustrated in (a) in the case of FIG. 8) and a process whose process context does not match (the process illustrated in (c) in the case of FIG. 8), and reconfigures the process definition. In this reconfiguration of the process definition, the states of the activities that have been executed are taken over.

At the time of displaying the reconfigured process definition to a user in, for instance, the process execution editing tool 26, the processes other than the reconfigured process, illustrated in (e) of FIG. 8, may be hidden from the user or distinguished in terms of display by, for instance, graying out.

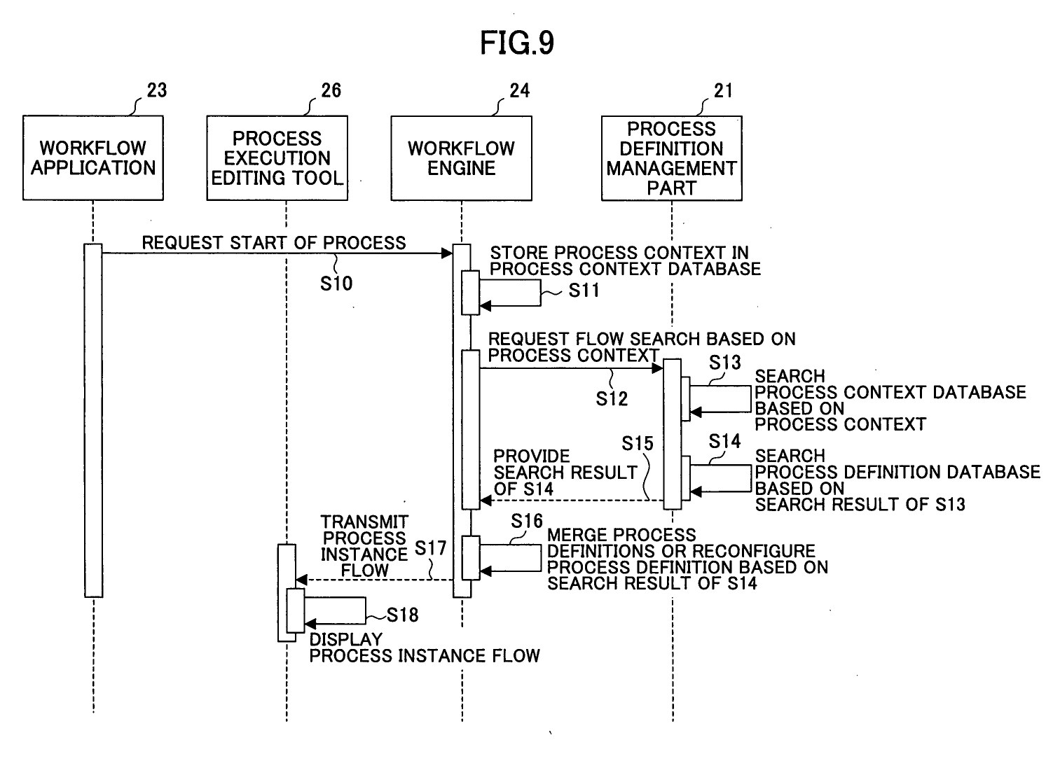

A description is given below, with reference to FIG. 9, of a process starting operation. FIG. 9 is a sequence diagram illustrating a process starting operation.

First, in step S10, the workflow application 23 transmits a request to start a process (process starting request) to the workflow engine 24 in response to a request from a user.

In step S11, receiving the process starting request, the workflow engine 24 stores, for instance, a process context relating to the start of the process in the process context database 27.

In step S12, the workflow engine 24 requests the process definition management part 21 to conduct, for instance, a flow search based on the process-start-related process context.

In step S13, the process definition management part 21 searches the process context database 27 based on the request from the workflow engine 24. For instance, the process definition management part 21 searches the process context database 27 for a process including the same process-start-related process context as that included in the request from the workflow engine 24.

In step S14, the process definition management part 21 searches the process definition database 22 based on the result of the search of step S13. For instance, the process definition management part 21 retrieves a process definition defining a process obtained as a result of the search of step S13 from the process definition database 22.

In step S15, the process definition management part 21 provides the workflow engine 24 with the result of the search of step S14.

In step S16, the workflow engine 24, for instance, merges process definitions (into a merged process definition) or reconfigures a process definition based on the process definitions that are the result of the search of step S14.

In step S17, the workflow engine 24 transmits a process instance flow converted into an instance based on the merged or reconfigured process definition to the process execution editing tool 26.

In step S18, the process execution editing tool 26 displays the process instance flow received in step S17.

By performing an operation as illustrated in FIG. 9, a user can proceed with a workflow without selecting a process definition at the beginning.

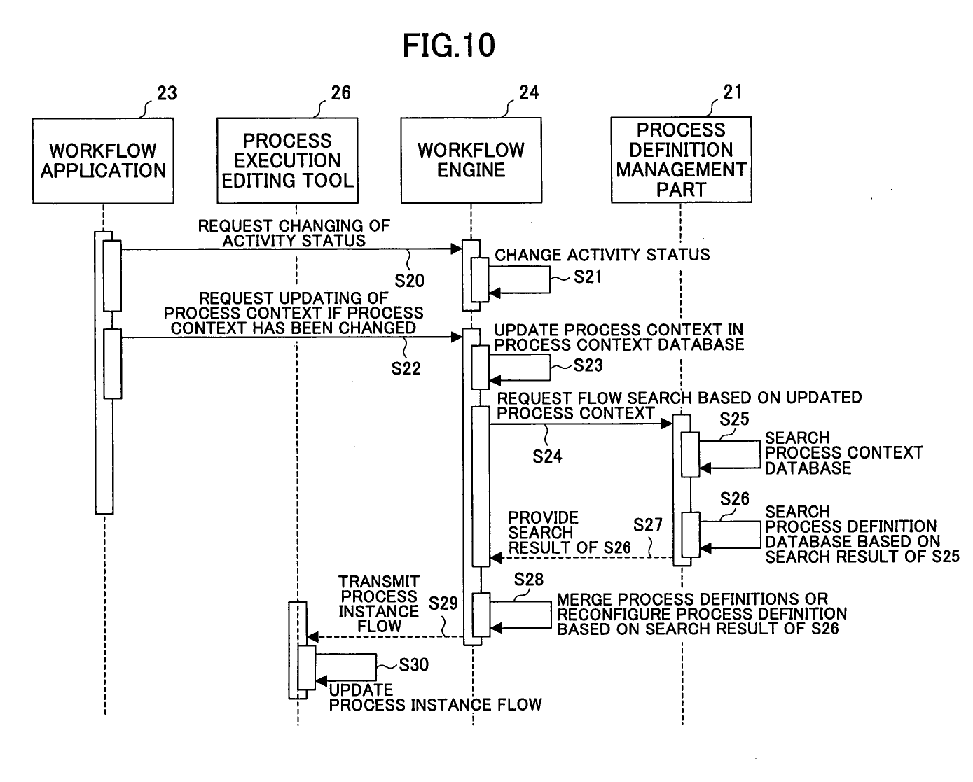

A description is given, with reference to FIG. 10, of a process advancing operation. FIG. 10 is a sequence diagram illustrating a process advancing operation.

First, in step S20, the workflow application 23 transmits a request to change the status of an activity to the workflow engine 24.

In step S21, receiving the request from the workflow application 23, the workflow engine 24 changes the status of the corresponding activity in the process instance database 25.

Here, for instance, if a user performs a process advancing operation such as activity completion, in step S22, the workflow application 23 transmits a request to update a process context to the workflow engine 24.

In step S23, receiving the request from the workflow application 23, the workflow engine 24 updates the corresponding process context in the process context database 27.

Next, in step S24, the workflow engine 24 requests the process definition management part 21 to conduct a flow search based on the process context updated in step S23 in order to narrow down the flows.

In step S25, the process definition management part 21 searches the process context database 27 based on the request from the workflow engine 24. For instance, the process definition management part 21 searches the process context database 27 for a process including the same process context as the updated process context included in the request from the workflow engine 24.

In step S26, the process definition management part 21 searches the process definition database 22 based on the search result of step S25. For instance, the process definition management part 21 retrieves a process definition defining a process obtained as a result of the search of step S25 from the process definition database 22.

In step S27, the process definition management part 21 provides the workflow engine 24 with the result of the search of step S26.

In step S28, the workflow engine 24, for instance, merges process definitions (into a merged process definition) or reconfigures a process definition based on the process definitions that are the result of the search of step S26.

In step S29, the workflow engine 24 transmits a process instance flow converted into an instance based on the merged or reconfigured process definition to the process execution editing tool 26.

In step S30, the process execution editing tool 26 updates a process instance flow that has been displayed based on the process instance flow received in step S29.

By performing an operation as illustrated in FIG. 10, a user can proceed with a workflow by narrowing down flows without selecting a process definition at the beginning.

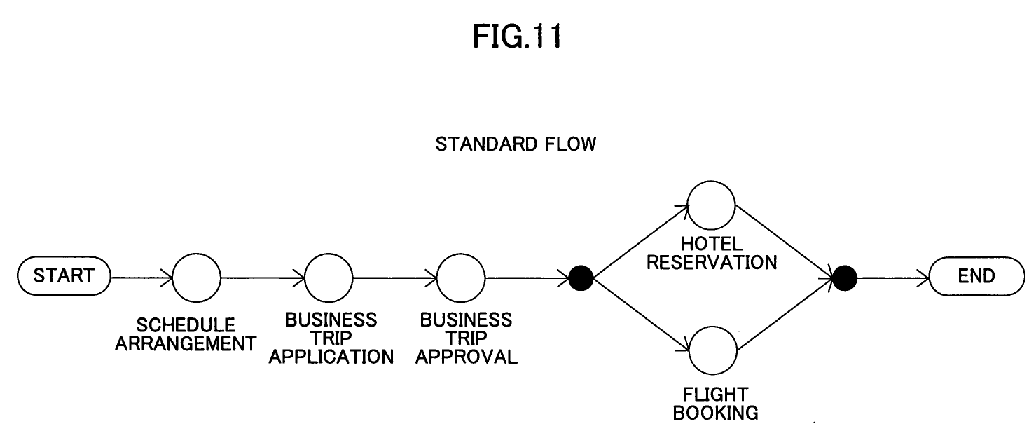

A description is given below of processing, taking a flow relating to application for an overseas business trip as an example. FIG. 11 is a diagram illustrating a standard flow relating to application for an overseas business trip.

According to the flow of FIG. 11, after arranging a schedule, applying for a business trip, and receiving approval of the business trip, hotel reservation and flight booking are performed in parallel.

In the following case, the process context is a purpose, a destination, and a business trip period.

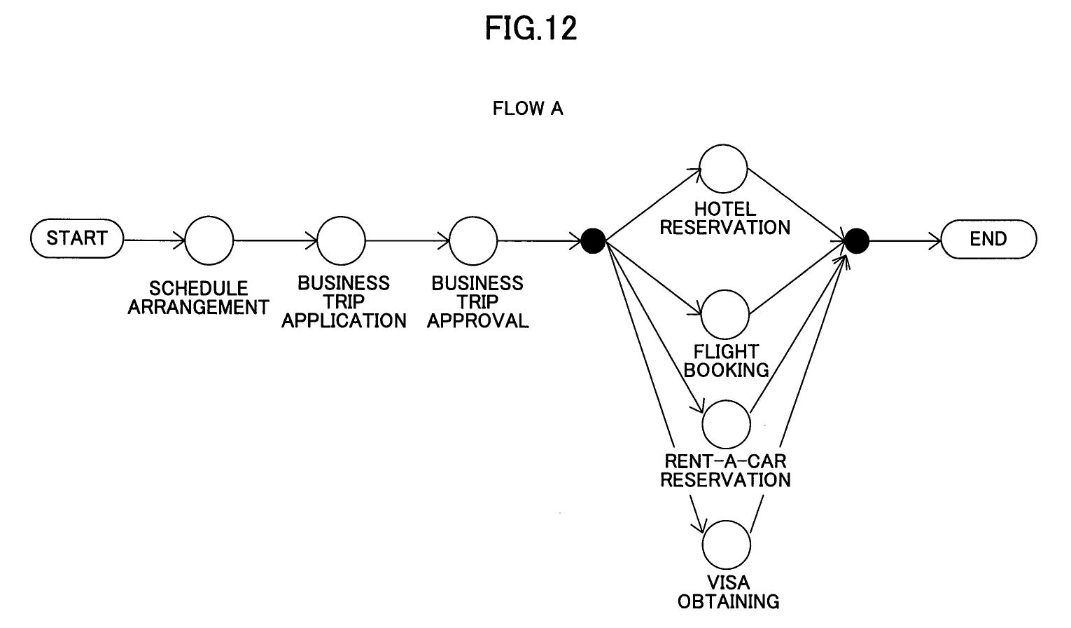

Next, a description is given below, with reference to FIG. 12, of a flow used to apply for an overseas business trip in the past. FIG. 12 is a diagram illustrating Flow A relating to application for an overseas business trip.

Flow A illustrated in FIG. 12 is a flow of application for the overseas business trip in which a purpose was system delivery, a destination was Canada, and a business trip period was 3 months. As the context and/or background of process execution, a visa was obtained and arrangements were made for a rent-a-car because of the length of the business trip.

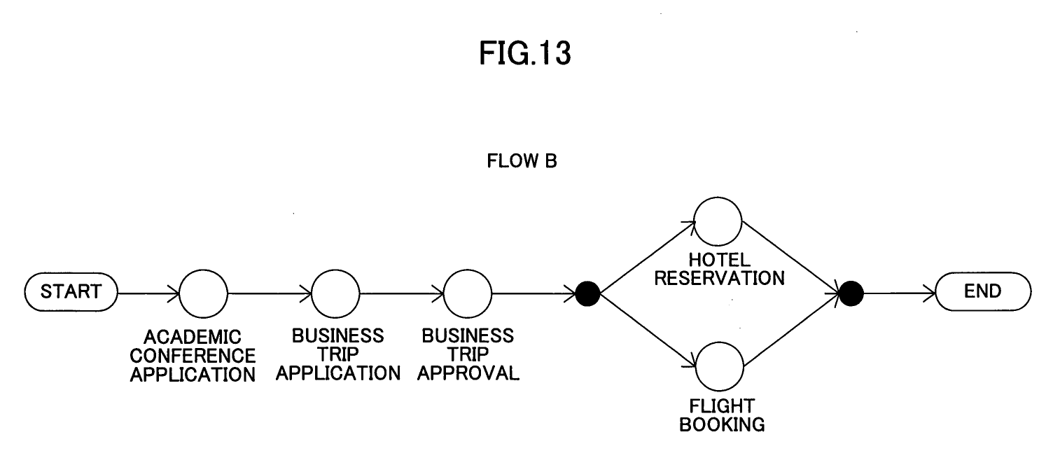

Next, a description is given below, with reference to FIG. 13, of another flow used to apply for an overseas business trip in the past. FIG. 13 is a diagram illustrating Flow B relating to application for an overseas business trip.

Flow B illustrated in FIG. 13 is a flow of application for the overseas business trip in which a purpose was attendance at an academic conference, a destination was the United States, and a business trip period was 1 week. As the context and/or background of process execution, processing for a required application for the academic conference was added.

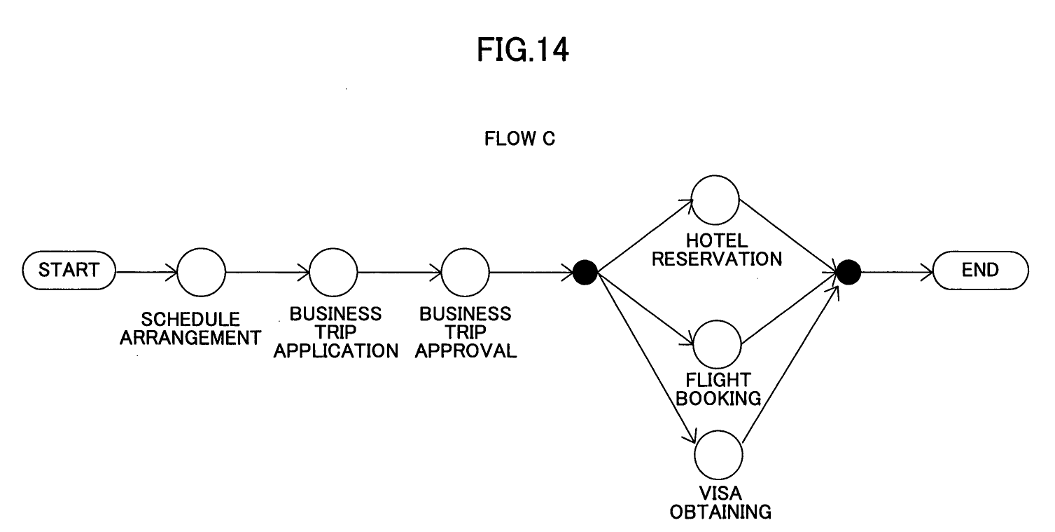

Next, a description is given below, with reference to FIG. 14, of another flow used to apply for an overseas business trip in the past. FIG. 14 is a diagram illustrating Flow C relating to application for an overseas business trip.

Flow C illustrated in FIG. 14 is a flow of application for the overseas business trip in which a purpose was development commission, a destination was China, and a business trip period was 1 week. As the context and/or background of process execution, it was necessary to obtain a visa because the destination was China.

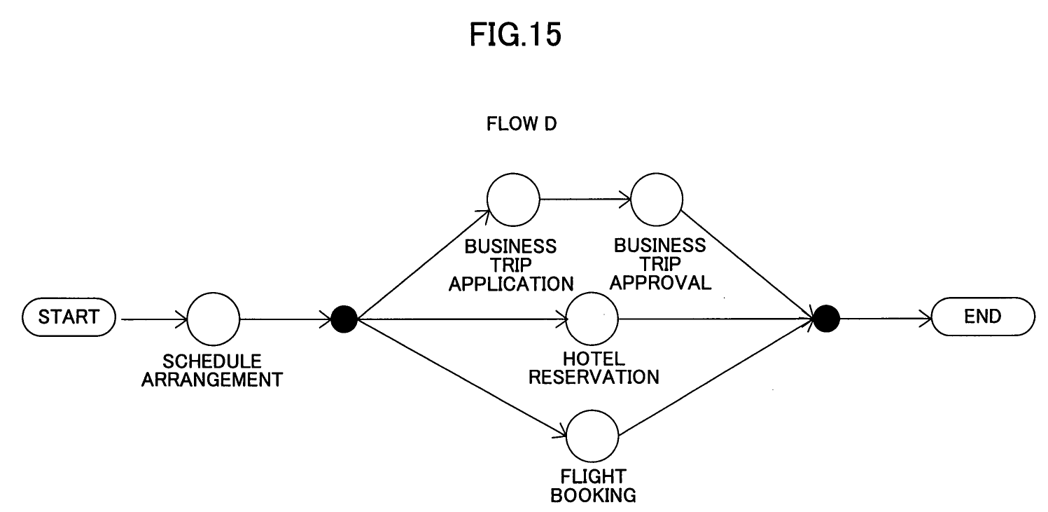

Next, a description is given below, with reference to FIG. 15, of another flow used to apply for an overseas business trip in the past. FIG. 15 is a diagram illustrating Flow D relating to application for an overseas business trip.

Flow D illustrated in FIG. 15 is a flow of application for the overseas business trip in which a purpose was fault investigation, a destination was the United States, and a business trip period was 2 weeks. As the context and/or background of process execution, hotel reservation and flight booking were performed in parallel with application for the business trip because of the urgency of the purpose.

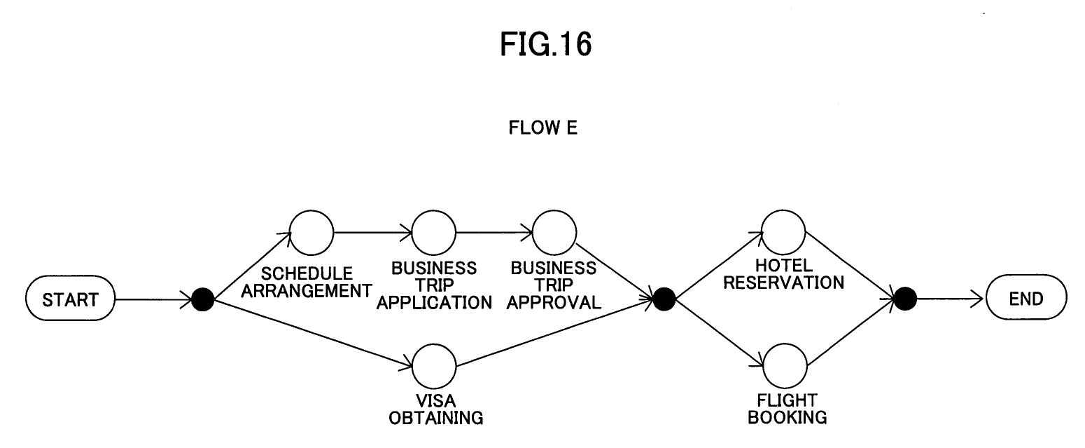

Next, a description is given below, with reference to FIG. 16, of another flow used to apply for an overseas business trip in the past. FIG. 16 is a diagram illustrating Flow E relating to application for an overseas business trip.

Flow E illustrated in FIG. 16 is a flow of application for the overseas business trip in which a purpose was fault investigation, a destination was China, and a business trip period was 1 week. As the context and/or background of process execution, the obtaining of a visa was advanced because of the urgency of the purpose.

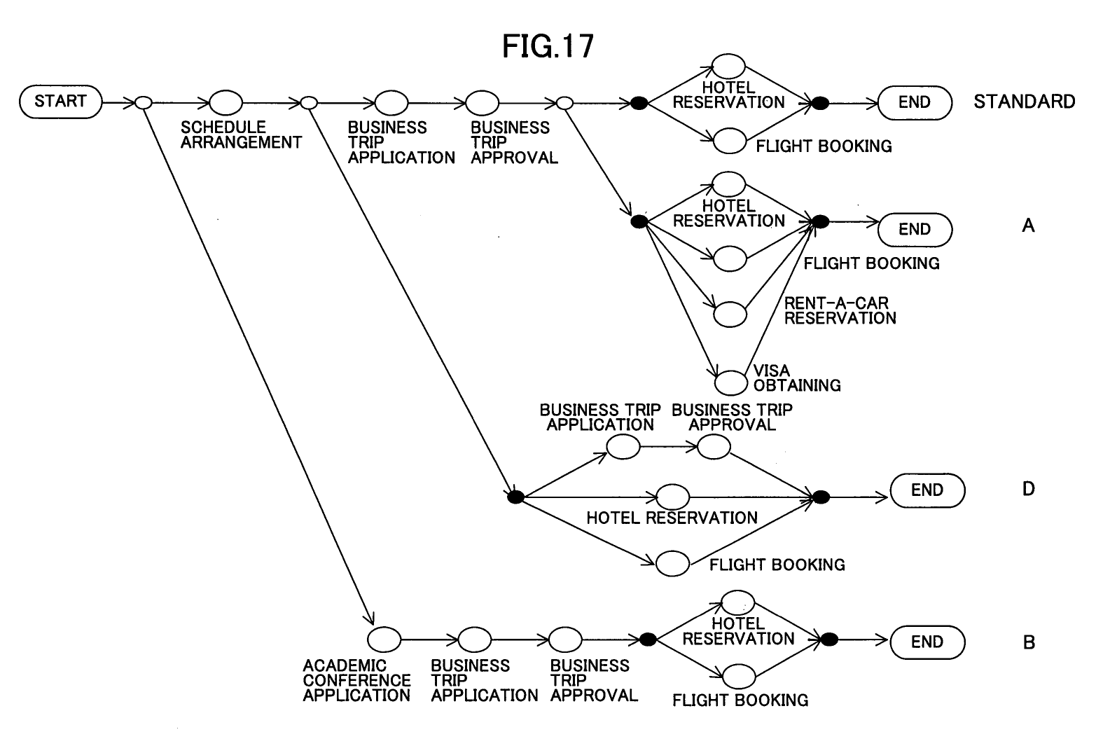

A description is given below, with reference to FIG. 17, of a flow relating to application for an overseas business trip. FIG. 17 is a diagram illustrating a flow relating to application for an overseas business trip.

First, when a user intends to execute the processing of application for an overseas business trip with a purpose being system delivery, a destination being the United States, and a business trip period being yet to be determined, the workflow engine 24, for instance, retrieves and merges Flows A, B, and D having the same purpose or destination as the business trip of the user, thereby creating a flow as illustrated in FIG. 17. As illustrated in FIG. 17, the workflow engine 24 can retrieve process definitions based on the process context, merge the retrieved process definitions, and present the user with a process definition based on the past records.

Here, because the purpose of this business trip is system delivery, the user manually selects not Flow B but the standard flow, Flow A, and Flow. D using, for instance, the process execution editing tool 26. At this point, the user displays the process context of each flow forming the basis of a corresponding branch using the process execution editing tool 26, and uses the process context as a reference in flow selection.

For instance, if the business trip turns out to be as long as 3 months as a result of schedule arrangement, the user finally selects and executes Flow A.

Thus, the user can start a workflow without selecting a process definition at the beginning.

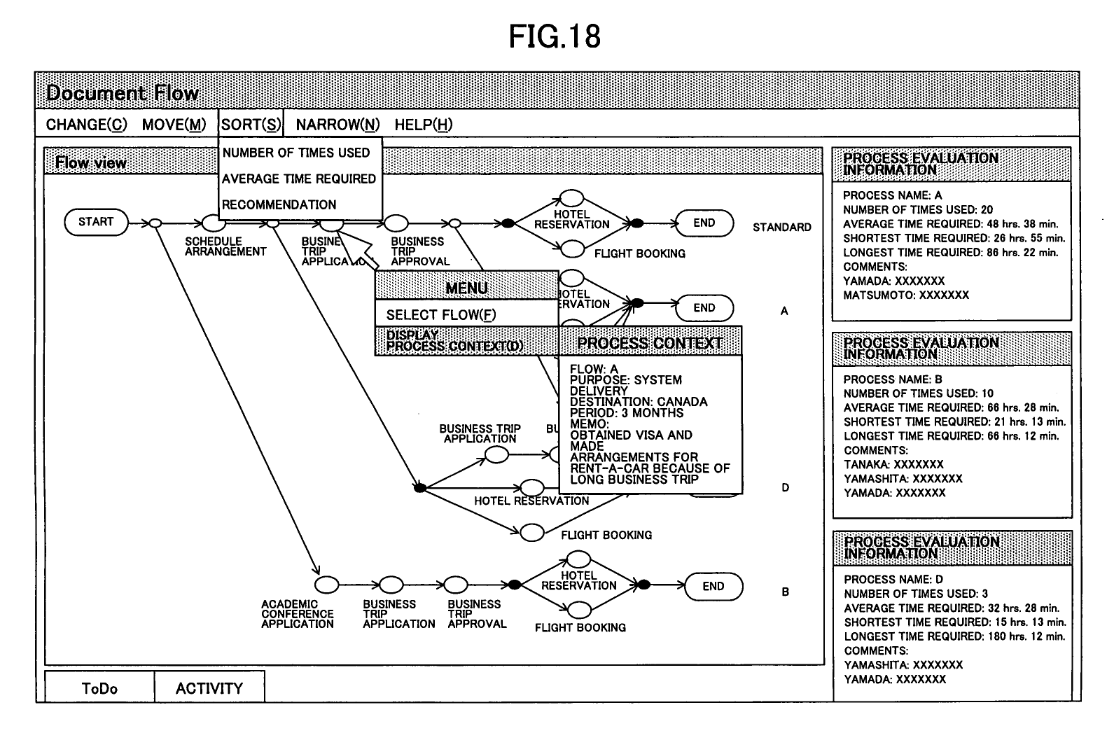

FIG. 18 is a diagram illustrating a case in which a process context is displayed as a reference in flow selection in the case of FIG. 17.

As illustrated in FIG. 18, in response to a request from the user, the process execution editing tool 26 displays, for instance, the process context of a flow forming the basis of a corresponding branch by obtaining the process context through the workflow engine 24.

The user can use the process context as a reference in flow selection by referring to the process context.

The process definition database 22 may store and manage a process definition together with the number of times the process definition is used. As a result, in response to a request from the user, the process execution editing tool 26 can rank process definitions according to the number of times used and present the user with processes (the process definitions) in the form of rankings.

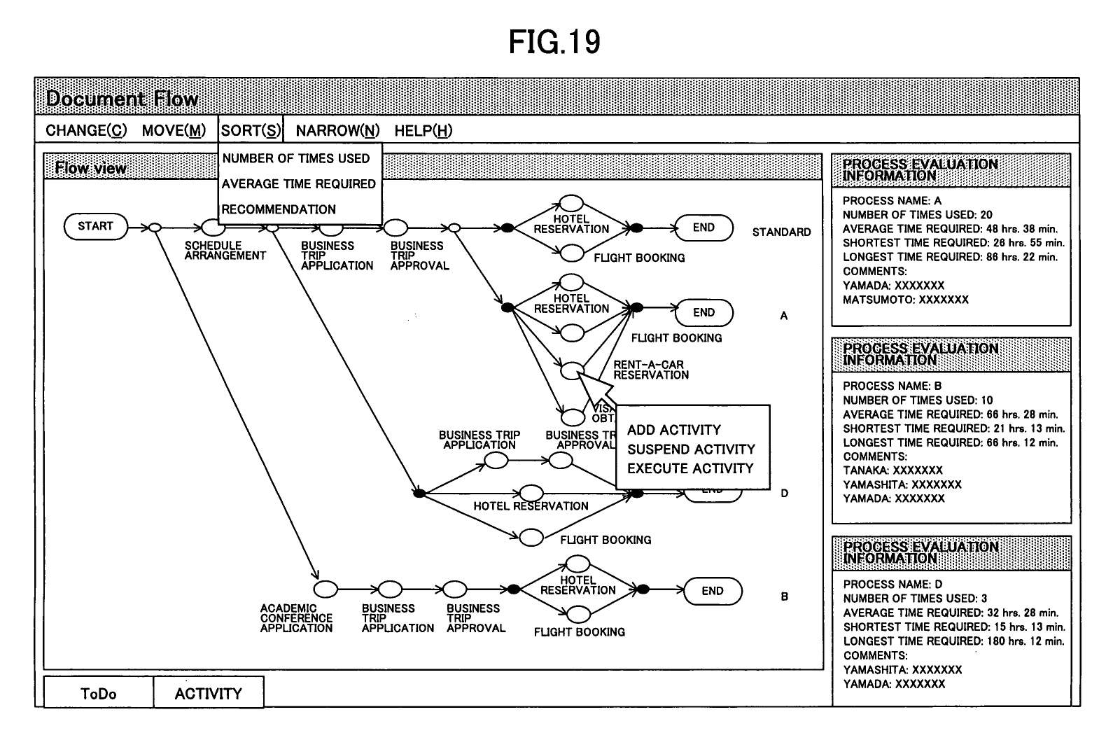

FIG. 19 is a diagram illustrating a case of adding an activity. As illustrated in FIG. 19, the process execution editing tool 26 adds an activity to a flow in execution in response to a request from a user.

The user can create a more optimal flow by her/himself by adding an activity to a flow in execution.

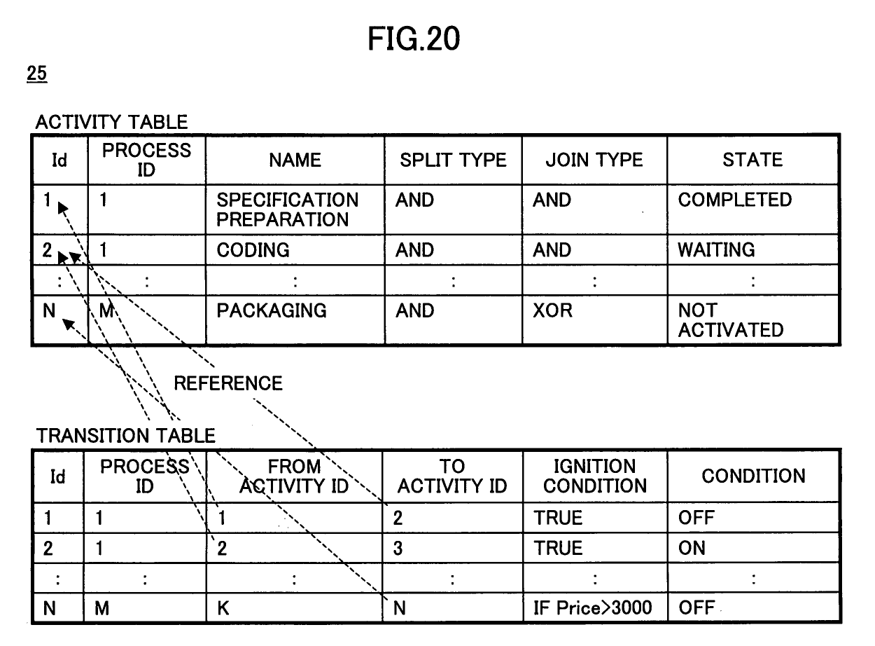

A description is given below, with reference to FIG. 20, of tables included in the process instance database 25. FIG. 20 illustrates an activity table and a transition table included in the process instance database 25.

Referring to FIG. 20, the activity table includes Id, Process ID, Name, Split Type, Join Type, and State as items.

In Id, an identifier identifying an activity is stored. In Process ID, an identifier identifying a process is stored. In Name, an activity name is stored. In Split Type, AND or XOR is stored as a type of splitting (branching). In Join Type, AND or XOR is stored as a type of joining. In State, NOT ACTIVATED, WAITING, ACTIVATED, COMPLETED, or SUSPENDED is stored as an activity state. Here, NOT ACTIVATED indicates that an activity remains unexecuted, WAITING indicates that an activity waits to be executed, ACTIVATED indicates that an activity is activated (being executed), COMPLETED indicates that an activity is completed, and SUSPENDED indicates that an activity is suspended.

Referring to FIG. 20, the transition table includes Id, Process ID, From Activity ID, To Activity ID, Ignition Condition, and Condition as items.

In Id, an identifier identifying an activity is stored. In Process ID, an identifier identifying a process is stored. In From Activity ID, an identifier identifying a starting-point activity is stored. In To Activity ID, an identifier identifying an end-point activity is stored. In Ignition Condition, the ignition condition of a transition is stored. In Condition, ON or OFF is stored as a transition condition (state).

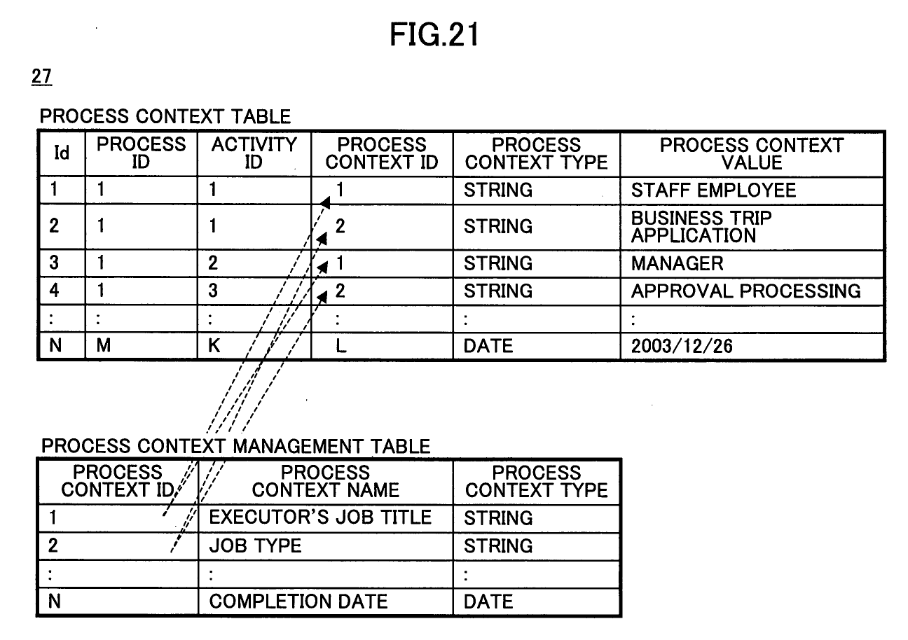

A description is given below, with reference to FIG. 21, of tables included in the process context database 27. FIG. 21 illustrates a process context table and a process context management table included in the process context database 27.

Referring to FIG. 21, the process context table includes Id, Process ID, Activity ID, Process Context Id, Process Context Type, and Process Context Value as items.

In Id, an identifier identifying a process context is stored. In Process ID, an identifier identifying a process is stored. In Activity ID, an identifier identifying an activity is stored. In Process Context ID, an identifier identifying a process context name is stored. In Process Context Type, for instance, STRING or DATE is stored as a type of process context value. In Process Context Value, the value of a process context (a process context value) is stored.

The process context management table includes Process Context ID, Process Context Name, and Process Context Type as items.

In Process Context ID, an identifier identifying a process context name is stored. In Process Context Name, the name of a process context (a process context name) is stored. In Process Context Type, for instance, STRING or DATE is stored as a type of process context value.

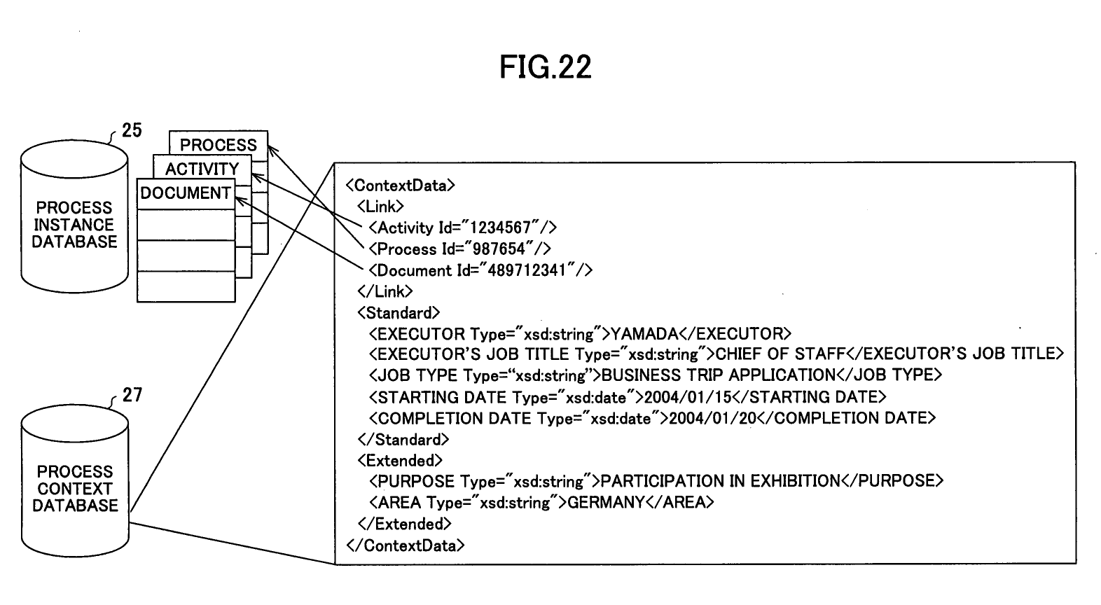

FIG. 22 is a diagram illustrating another configuration of the process context database 27.

As illustrated in FIG. 22, the process context database 27 may be configured as an XML (extensible Markup Language) database (XMLDB), which can store structured information as it is, so as to be freely customizable in accordance with the purpose of use.

### Second Embodiment

A description is given below of a case where processes are narrowed down before merging process definitions using the degree of similarity of a process context (process context similarity) according to a second embodiment of the present invention. In the following, a description is given of the differences from the first embodiment.

For instance, the workflow engine 24 calculates the process context similarity by assigning corresponding weight to each process context value and summing up matching process context values. For instance, the workflow engine 24 calculates the process context similarity based on the following equation:

$$Similarity = {\sum }_{i = 1}^{n} ( {w}_{i} * equals ( {C}_{Ii} , {C}_{IIi} ) ) ,$$

where n is a natural number greater than or equal to one and represents the number of process contexts, Wi (i=1, 2, . . . , n) is a corresponding weight assigned to each process context, and C_{I1}, C_{I2}, . . . , C_{In} and C_{II1}, C_{II2}, . . . , C_{IIn} are process context values of two different process definitions (Process Definition I and Process Definition II). Further, equals (a, b) is a function that returns 1 when a=b.

For instance, the workflow engine 24 sets a predetermined threshold with respect to the similarities calculated based on the above-described equation. Then, the workflow engine 0.24 determines that the processes having a similarity greater than or equal to the threshold are similar processes, or determines that the processes are similar in the descending order of the similarities calculated based on the above-described equation. Thus, the workflow engine 24 employs the process context similarity in narrowing down processes before merging process definitions.

By the workflow engine 24 calculating similarities, for instance, the process execution editing tool 26 can rank process definitions based on the similarities and present a user with processes (or the process definitions) in the form of rankings in response to a request from the user.

The above-described formula is an example, and the workflow engine 24 may employ another formula to calculate the process context similarity.

As described above, according to the present invention, by narrowing down numerous process definitions toward a process definition to be executed, a user can start a process (workflow) without selecting one process definition definitely. Further, according to the present invention, a process can be clarified automatically in accordance with the process context during its execution.

The present invention is not limited to the specifically disclosed embodiments, and variations and modifications may be made without departing from the scope of the present invention.

The present application is based on Japanese Priority Patent Applications No. 2004-046861, filed on Feb. 23, 2004, and No. 2005-021498, filed on Jan. 28, 2005, the entire contents of which are hereby incorporated by reference.

1. A process management apparatus, comprising:
a process execution control part configured to control execution of a process, the process execution control part being configured to retrieve multiple process definitions that are process templates based on context information relating to the execution of the process, and to perform one of merging of the retrieved process definitions into a process definition and reconfiguration of a process definition based on the retrieved process definitions, so as to allow a user to proceed with the process without selecting the process definition.

2. The process management apparatus as claimed in claim 1, wherein the process execution control part provides a user terminal apparatus connected to the process management apparatus via a network with a process instance flow converted into an instance based on the process definition by one of the merging and the reconfiguration.

3. The process management apparatus as claimed in claim 1, further comprising:
a process definition storage part configured to store a plurality of process definitions including process definitions of a same kind.

4. The process management apparatus as claimed in claim 1, wherein the context information is stored in a context information storage part at a time of executing the process, the context information storage part being configured to store the context information.

5. The process management apparatus as claimed in claim 4, further comprising:
the context information storage part.

6. The process management apparatus as claimed in claim 1, wherein the process execution control part performs the reconfiguration of the process definition by decomposing the process definition forming the process in execution into multiple process definitions before being merged, extracting two or more of the multiple process definitions before being merged which two or more have the matching context information, and merging the extracted process definitions when the context information is changed during the execution of the process.

7. A user terminal apparatus, comprising:
a process editing part configured to perform process editing, the process editing part being configured to display on a screen one of a first process into which multiple processes are merged and a second process reconfigured based on the multiple processes, and to display context information relating to execution of the one of the first and second processes in response to a request.

8. The user terminal apparatus as claimed in claim 7, wherein the process editing part receives a process instance flow converted into an instance based on one of a first process definition into which multiple process definitions are merged and a second process definition reconfigured based on the multiple process definitions in a process management apparatus connected to the user terminal apparatus via a network, and displays the process instance flow on the screen as the one of the first and second processes.

9. The user terminal apparatus as claimed in claim 7, wherein:
the one of the first and second processes includes the multiple processes; and
the process editing part displays the multiple processes on the screen in accordance with rankings of numbers of times used of the multiple processes or multiple process definitions that are templates of the multiple processes.

10. The user terminal apparatus as claimed in claim 7, wherein:
the one of the first and second processes includes the multiple processes; and
the process editing part displays the multiple processes on the screen in accordance with rankings of similarities of the multiple processes or multiple process definitions that are templates of the multiple processes.

11. A computer-readable recording medium on which a program for causing a computer to execute a method of managing a process is recorded, the method comprising the step of:
controlling execution of the process,
wherein said step retrieves multiple process definitions that are process templates based on context information relating to the execution of the process, and performs one of merging of the retrieved process definitions into a process definition and reconfiguration of a process definition based on the retrieved process definitions, so as to allow a user to proceed with the process without selecting the process definition.

12. The computer-readable recording medium as claimed in claim 11, wherein said step provides a user terminal apparatus connected to the computer via a network with a process instance flow converted into an instance based on the process definition by one of the merging and the reconfiguration.

13. The computer-readable recording medium as claimed in claim 11, wherein said step stores the context information in a context information storage part at a time of executing the process, the context information storage part being configured to store the context information.

14. The computer-readable recording medium as claimed in claim 11, wherein said step performs the reconfiguration of the process definition by decomposing the process definition forming the process in execution into multiple process definitions before being merged, extracting two or more of the multiple process definitions before being merged which two or more have the matching context information, and merging the extracted process definitions when the context information is changed during the execution of the process.

15. A computer-readable recording medium on which a program for causing a computer to execute a method of process execution is recorded, the method comprising the step of:
performing process editing,
wherein said step displays on a screen one of a first process into which multiple processes are merged and a second process reconfigured based on the multiple processes, and displays context information relating to execution of the one of the first and second processes in response to a request.

16. The computer-readable recording medium as claimed in claim 15, wherein said step receives a process instance flow converted into an instance based on one of a first process definition into which multiple process definitions are merged and a second process definition reconfigured based on the multiple process definitions in a process management apparatus connected to the computer via a network, and displays the process instance flow on the screen as the one of the first and second processes.

17. The computer-readable recording medium as claimed in claim 15, wherein:
the one of the first and second processes includes the multiple processes; and
said step displays the multiple processes on the screen in accordance with rankings of numbers of times used of the multiple processes or multiple process definitions that are templates of the multiple processes.

18. The computer-readable recording medium as claimed in claim 15, wherein:
the one of the first and second processes includes the multiple processes; and
said step displays the multiple processes on the screen in accordance with rankings of similarities of the multiple processes or multiple process definitions that are templates of the multiple processes.

19. A method of managing a process in a process management apparatus, the method comprising the step of:
controlling execution of the process,
wherein said step retrieves multiple process definitions that are process templates based on context information relating to the execution of the process, and performs one of merging of the retrieved process definitions into a process definition and reconfiguration of a process definition based on the retrieved process definitions, so as to allow a user to proceed with the process without selecting the process definition.

20. A method of process execution in a user terminal apparatus, the method comprising the step of:
performing process editing,
wherein said step displays on a screen one of a first process into which multiple processes are merged and a second process reconfigured based on the multiple processes, and displays context information relating to execution of the one of the first and second processes in response to a request.
